(19) United States
(12) Patent Application Publication
(10) Pub. No.: US 2024/0159247 A1
(43) Pub. Date: May 16, 2024

(54) Casing Treatment for Gas Turbine Engines

(71) Applicant: Raytheon Technologies Corporation, Farmington, CT (US)

(72) Inventors: Michael M. JOLY, Hebron, CT (US); Joseph KATZ, Farmington, CT (US)

(21) Appl. No.: 18/197,429

(22) Filed: May 15, 2023

Related U.S. Application Data
(60) Provisional application No. 63/389,395, filed on Jul. 15, 2022.

(51) Int. Cl. F04D 29/52; F04D 27/02

(52) U.S. Cl. CPC F04D 29/526; F04D 27/0238; F05D 2240/14; F05D 2250/75; F05D 2260/60

(57) ABSTRACT

Compressor sections of gas turbine engines include a casing, a rotor arranged within with casing, the rotor having a plurality of blades that are rotatable relative to the casing, and a casing treatment applied to the casing. The casing treatment includes a plurality of covered channels each having an inlet and an outlet and a partially covered cavity defined between the inlet and the outlet in an axial direction and between a cover wall and a casing wall in a radial direction relative to an axis through the casing. A core flow through the casing is in a core flow direction and a recirculation flow through the plurality of covered channels is in a recirculation flow direction, the recirculation flow direction being counter to the core flow direction, and the inlet is at a position downstream relative to the outlet in the core flow direction.

### CROSS REFERENCE TO RELATED APPLICATIONS

This application claims priority to U.S. Provisional Patent Application No. 63/389,395 filed on Jul. 15, 2022, the contents of which are incorporated herein by reference thereto.

### STATEMENT OF FEDERAL SUPPORT

This invention was made with Government support under Contract No. N00014-18-1-2430 awarded by the United States Navy. The Government has certain rights in this invention.

### BACKGROUND

The subject matter disclosed herein generally relates to gas turbine engines and, more particularly, to casing treatments of gas turbine engines.

A limiting factor in gas turbine engine performance may be related to the stability of the compression system. In that regard, greater stability in the compression system supports improved engine operation. The stability of the compression system in a gas turbine engine may be limited by both the engine operating conditions and stall capability of the compressor. In some compressors, the initiation of a stall may be driven by tip leakage flow through a tip clearance between an airfoil and an outer diameter (e.g., casing) of the compressor. The detrimental characteristics of tip leakage flow may predominantly be from reverse tip leakage flow, that is, tip leakage flow moving in an aft-to-forward direction (counter to a core flow through the engine core).

Alterations to improve compressor stability by increasing the stall margin, for example, typically result in reduced engine efficiency. Casing treatments, such as geometric modifications of the walls of the compressor case, may have resulted in reduced engine efficiency at engine design conditions (e.g., cruise) in previous applications.

### SUMMARY

According to some embodiments, compressor sections of gas turbine engines are provided. The compressor sections include a casing, a rotor arranged within with casing, the rotor having a plurality of blades that are rotatable relative to the casing, and a casing treatment applied to the casing. The casing treatment includes a plurality of covered channels each having an inlet and an outlet and a partially covered cavity defined between the inlet and the outlet in an axial direction and between a cover wall and a casing wall in a radial direction relative to an axis through the casing, and a core flow through the casing is in a core flow direction and a recirculation flow through the plurality of covered channels is in a recirculation flow direction, the recirculation flow direction being counter to the core flow direction, and the inlet is at a position downstream relative to the outlet in the core flow direction.

In addition to one or more of the features described herein, or as an alternative, further embodiments of the compressor sections may include that a leading edge of a blade tip of each blade is positioned relative to the covered wall at a point between the inlets and the outlets of the casing treatment.

In addition to one or more of the features described herein, or as an alternative, further embodiments of the compressor sections may include that the point is closer to the outlet than the inlet.

In addition to one or more of the features described herein, or as an alternative, further embodiments of the compressor sections may include that the inlet and the outlet are separated in an axial direction and aligned in a circumferential direction, wherein the axial direction is along the axis through the casing and parallel to the core flow direction and wherein the circumferential direction is a direction of rotation of the rotor about the axis.

In addition to one or more of the features described herein, or as an alternative, further embodiments of the compressor sections may include that the inlet and the outlet are separated in an axial direction and offset in a circumferential direction, wherein the axial direction is along the axis through the casing and parallel to the core flow direction and wherein the circumferential direction is a direction of rotation of the rotor about the axis.

In addition to one or more of the features described herein, or as an alternative, further embodiments of the compressor sections may include that each covered channel has a generally J-shape between the inlet and the outlet.

In addition to one or more of the features described herein, or as an alternative, further embodiments of the compressor sections may include that each covered channel has a generally curved shape between the inlet and the outlet.

In addition to one or more of the features described herein, or as an alternative, further embodiments of the compressor sections may include that each covered channel has a generally S-shape between the inlet and the outlet.

In addition to one or more of the features described herein, or as an alternative, further embodiments of the compressor sections may include that each covered channel has a generally U-shape between the inlet and the outlet.

In addition to one or more of the features described herein, or as an alternative, further embodiments of the compressor sections may include that each covered channel of the casing treatment has a treatment length and the cover wall has a wall length, wherein the wall length is between 30% and 90% of the treatment length.

According to some embodiments, gas turbine engines are provided. the gas turbine engines include a fan, a compressor section, a combustor section, and a turbine section arranged along an engine shaft, with a core flow passing through gas turbine engine in a core flow direction. The compressor section includes a casing, a rotor arranged within with casing, the rotor comprising a plurality of blades that are rotatable relative to the casing, and a casing treatment applied to the casing. The casing treatment includes a plurality of covered channels each having an inlet and an outlet and a partially covered cavity defined between the inlet and the outlet in an axial direction and between a cover wall and a casing wall in a radial direction relative to an axis through the casing, a core flow through the casing is in a core flow direction and a recirculation flow through the plurality of covered channels is in a recirculation flow direction, the recirculation flow direction being counter to the core flow direction, and the inlet is at a position downstream relative to the outlet in the core flow direction.

In addition to one or more of the features described herein, or as an alternative, further embodiments of the gas turbine engines may include that a leading edge of a blade tip of each blade is positioned relative to the covered wall at a point between the inlets and the outlets of the casing treatment.

In addition to one or more of the features described herein, or as an alternative, further embodiments of the gas turbine engines may include that the point is closer to the outlet than the inlet.

In addition to one or more of the features described herein, or as an alternative, further embodiments of the gas turbine engines may include that the inlet and the outlet are separated in an axial direction and aligned in a circumferential direction, wherein the axial direction is along the axis through the casing and parallel to the core flow direction and wherein the circumferential direction is a direction of rotation of the rotor about the axis.

In addition to one or more of the features described herein, or as an alternative, further embodiments of the gas turbine engines may include that the inlet and the outlet are separated in an axial direction and offset in a circumferential direction, wherein the axial direction is along the axis through the casing and parallel to the core flow direction and wherein the circumferential direction is a direction of rotation of the rotor about the axis.

In addition to one or more of the features described herein, or as an alternative, further embodiments of the gas turbine engines may include that each covered channel has a generally J-shape between the inlet and the outlet.

In addition to one or more of the features described herein, or as an alternative, further embodiments of the gas turbine engines may include that each covered channel has a generally curved shape between the inlet and the outlet.

In addition to one or more of the features described herein, or as an alternative, further embodiments of the gas turbine engines may include that each covered channel has a generally S-shape between the inlet and the outlet.

In addition to one or more of the features described herein, or as an alternative, further embodiments of the gas turbine engines may include that each covered channel has a generally U-shape between the inlet and the outlet.

In addition to one or more of the features described herein, or as an alternative, further embodiments of the gas turbine engines may include that each covered channel of the casing treatment has a treatment length and the cover wall has a wall length, wherein the wall length is between 30% and 90% of the treatment length.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The subject matter is particularly pointed out and distinctly claimed at the conclusion of the specification. The foregoing and other features, and advantages of the present disclosure are apparent from the following detailed description taken in conjunction with the accompanying drawings in which:

FIG. 1 is a schematic cross-sectional illustration of a gas turbine engine that may incorporate embodiments of the present disclosure;

FIG. 2A schematically illustrations a portion of a compressor section of a gas turbine engine that may incorporate embodiments of the present disclosure;

FIG. 2B is an alternative view of the portion of the compressor section of FIG. 2A;

FIG. 3A is a schematic illustration of a portion of a compressor section having a casing treatment in accordance with an embodiment of the present disclosure;

FIG. 3B illustrates the compressor section of FIG. 3A with a blade arranged relative to the casing treatment;

FIG. 4 is a schematic plot illustrating performance efficiency of different types of casing treatments applied to compressor sections of a gas turbine engine;

FIG. 5 is a schematic illustration of a casing treatment in accordance with an embodiment of the present disclosure;

FIG. 6 includes example geometries of casing treatments in accordance with embodiments of the present disclosure;

FIG. 7A is a schematic illustration of a casing treatment in accordance with an embodiment of the present disclosure; and

FIG. 7B is a side cross-sectional view of the casing treatment of FIG. 7A.

### DETAILED DESCRIPTION

As shown and described herein, various features of the disclosure will be presented. Various embodiments may have the same or similar features and thus the same or similar features may be labeled with the same reference numeral, but preceded by a different first number indicating the figure to which the feature is shown. Although similar reference numbers may be used in a generic sense, various embodiments will be described and various features may include changes, alterations, modifications, etc. as will be appreciated by those of skill in the art, whether explicitly described or otherwise would be appreciated by those of skill in the art.

Detailed descriptions of one or more embodiments of the disclosed apparatus and/or methods are presented herein by way of exemplification and not limitation with reference to the Figures.

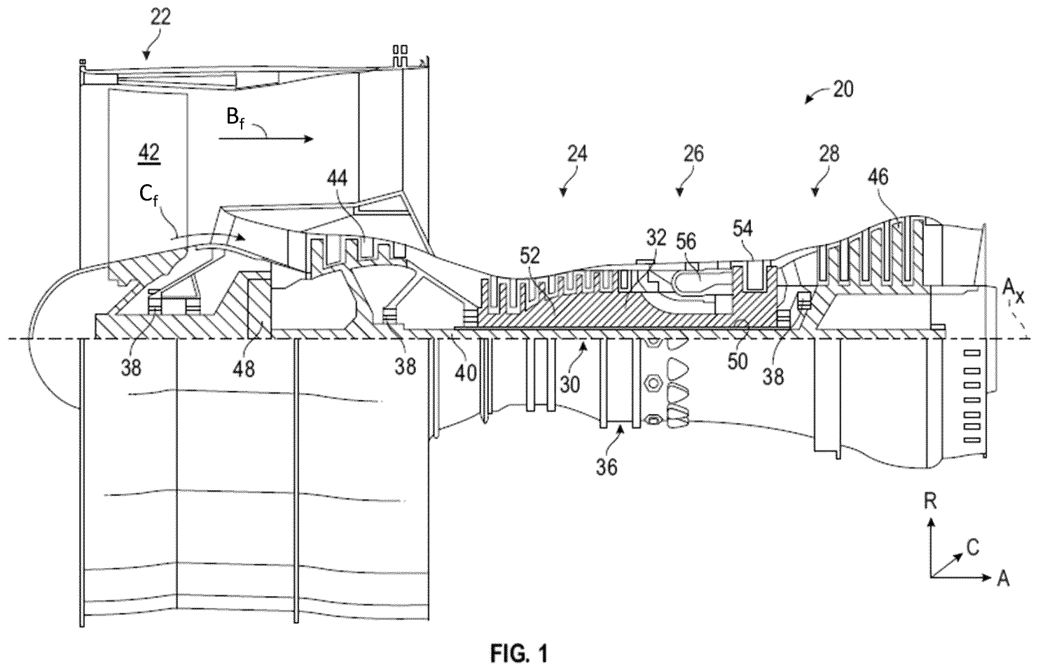

FIG. 1 schematically illustrates a gas turbine engine 20. The gas turbine engine 20 is disclosed herein as a two-spool turbofan that generally incorporates a fan section 22, a compressor section 24, a combustor section 26 and a turbine section 28. The fan section 22 drives air along a bypass flow path B_{f} in a bypass duct, while the compressor section 24 drives air along a core flow path C_{f} for compression and communication into the combustor section 26 then expansion through the turbine section 28. With reference to FIG. 1, as used herein, “aft” refers to the direction associated with the tail (e.g., the back end) of an aircraft, or generally, to the direction of exhaust of the gas turbine engine (to the right in FIG. 1). The term “forward” refers to the direction associated with the nose (e.g., the front end) of an aircraft, or generally, to the direction of flight or motion (to the left in FIG. 1). An axial direction A is along an engine central longitudinal axis, referred to as engine axis Aₓ (left and right on FIG. 1). Further, radially inward refers to a negative radial direction relative to the engine axis Aₓ and radially outward refers to a positive radial direction (radial being up and down in the cross-section of the page of FIG. 1). A circumferential direction C is a direction relative to the engine axis Aₓ (e.g., a direction of rotation of components of the engine; in FIG. 1, circumferential is a direction into and out of the page, when offset from the engine axis Aₓ). An A-R-C coordinate axis is shown in FIG. 1.

The gas turbine engine 20 includes a low speed spool 30 and a high speed spool 32 mounted for rotation about the engine axis Aₓ relative to an engine static structure 36 via several bearing systems 38. It should be understood that various bearing systems 38 at various locations may alternatively or additionally be provided, and the location of bearing systems 38 may be varied as appropriate to the application.

The low speed spool 30 generally includes an inner shaft 40 that interconnects a fan 42, a low pressure compressor 44, and a low pressure turbine 46. The inner shaft 40 is connected to the fan 42 through a speed change mechanism, such as a geared architecture 48 to drive the fan 42 at a lower speed than the rotational speed of the low speed spool 30. The high speed spool 32 includes an outer shaft 50 that interconnects a high pressure compressor 52 and high pressure turbine 54. A combustor 56 is arranged between the high pressure compressor 52 and the high pressure turbine 54. An engine static structure 36 supports, for example, the bearing systems 38 in the turbine section 28. The inner shaft 40 and the outer shaft 50 are concentric and rotate via the bearing systems 38 about the engine axis Aₓ which is collinear with the longitudinal axes of the shafts 40, 50.

Core airflow is compressed by the low pressure compressor 44, then the high pressure compressor 52, mixed and burned with fuel in the combustor 56, and expanded over the high pressure turbine 54 and the low pressure turbine 46. The turbines 46, 54 rotationally drive the respective low speed spool 30 and high speed spool 32 in response to the expansion. It will be appreciated that each of the positions of the fan section 22, the compressor section 24, the combustor section 26, the turbine section 28, and the fan drive gear system 48 may be varied. For example, the gear system 48 may be located aft of the combustor section 26 or even aft of the turbine section 28, and the fan section 22 may be positioned forward or aft of the location of the gear system 48.

The gas turbine engine 20 in one non-limiting example is a high-bypass geared aircraft engine. In one such example, the bypass ratio of the gas turbine engine 20 is greater than about six (6), with an example embodiment being greater than about ten (10). The geared architecture 48 may be an epicyclic gear train, such as a planetary gear system or other gear system, with a gear reduction ratio of greater than about 2.3. The low pressure turbine 46 may have a pressure ratio that is greater than about five (5). As noted, in one disclosed embodiment, the bypass ratio of the gas turbine engine 20 may be greater than about ten (10:1). In such an example, a diameter of the fan (fan 42) may be significantly larger than that of the low pressure compressor 44. Additionally, in such an embodiment, the low pressure turbine 46 may have a pressure ratio that is greater than about five (5:1). The pressure ratio of the low pressure turbine 46 may be pressure measured prior to an inlet of the low pressure turbine 46 as related to the pressure at the outlet of the low pressure turbine 46 prior to an exhaust nozzle.

In some non-limiting embodiments, the geared architecture 48 may be an epicycle gear train, such as a planetary gear system or other gear system, with a gear reduction ratio of greater than about 2.3:1. It should be understood, however, that the above parameters are only for example purposes of a geared architecture engine and that the present disclosure is applicable to other gas turbine engines including direct drive turbofans.

A significant amount of thrust is provided by the bypass flow B_{f} due to the high bypass ratio. The fan section 22 of the gas turbine engine 20 may be designed for a particular flight condition—typically cruise at about 0.8Mach and about 35,000 feet (10,688 meters). The flight condition of 0.8 Mach and 35,000 ft (10,688 meters), with the engine at its best fuel consumption—also known as “bucket cruise Thrust Specific Fuel Consumption (“TSFC”)”—is the industry standard parameter of lbm of fuel being burned divided by lbf of thrust the engine produces at that minimum point. “Low fan pressure ratio” is the pressure ratio across the fan blade alone, without a Fan Exit Guide Vane (“FEGV”) system. The low fan pressure ratio as disclosed herein according to one non-limiting embodiment is less than about 1.45. “Low corrected fan tip speed” is the actual fan tip speed in ft/sec divided by an industry standard temperature correction of [(Tram ° R)/(518.7° R)]^{0.5}. The “Low corrected fan tip speed” as disclosed herein according to one non-limiting embodiment is less than about 1150 ft/second (350.5 m/sec).

Although the gas turbine engine 20 is depicted as a turbofan, it should be understood that the concepts described herein are not limited to use with the described configuration, as the teachings may be applied to other types of engines such as, but not limited to, turbojets, turboshafts, etc.

In operation, one limiting factor of engine performance is associated with stability of fans and/or rotors of the engines. The stability of fans and compresses in gas turbine engines may be controlled by the quality of the flow in a tip clearance region of a rotating blade. That is, as the rotating blade is rotated relative to a casing of the engine, the flow quality at the tip of the blade (e.g., between the tip of the blade and the casing) impacts engine operation, stability, and efficiency. As will be appreciated by those of skill in the art, interactions of the leakage flow and tip leakage vortex with the passage flow may generate flow blockage that is higher than design intents, and the associated instabilities can cause formation of rotating stall and surge. In some engines, casing treatments are applied to reduce the stall potential, and thus increase the stall margin of the engines. However, this increased stall margin may have a negative impact to the engine performance at high flow rates of peak engine operation (e.g., as stall margin is increased, total performance may go down).

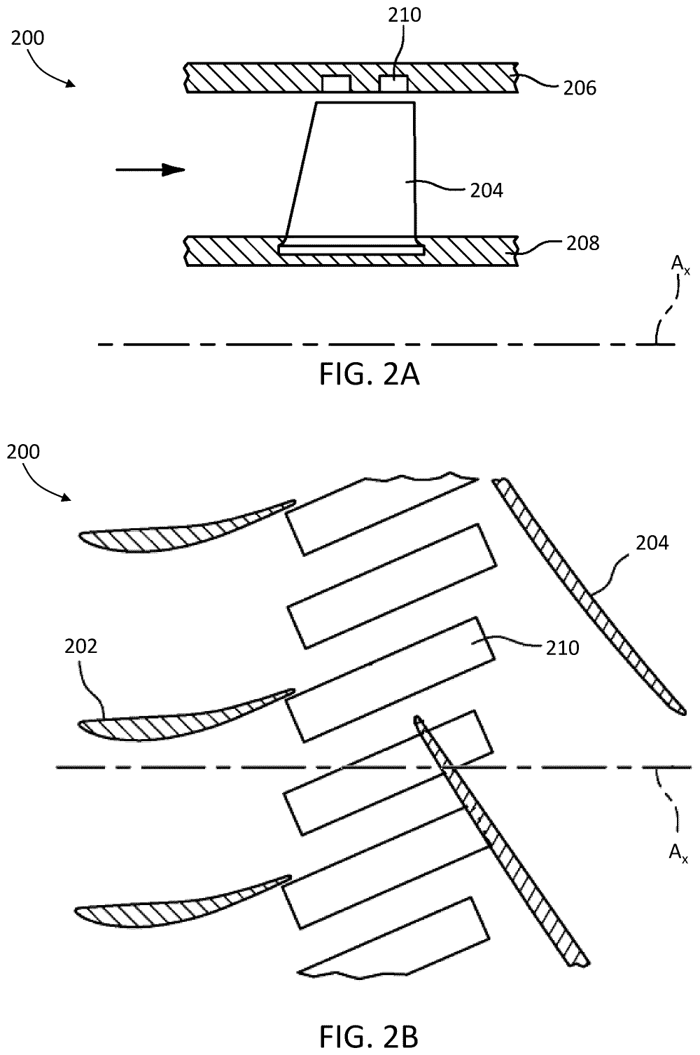

Referring now to FIGS. 2A-2B, schematic illustrations of a portion of a compressor section 200 of a gas turbine engine that may incorporate embodiments of the present disclosure are shown. FIG. 2A is a side view of the compressor section 200 and FIG. 2B is a radially inward view of the compressor section 200.

The compressor section 200 includes a plurality of stationary vanes 202 and rotating rotor blades 204. The vanes 202 may be fixedly attached to a casing 206 or other static structure of a gas turbine engine. The blades 204 are affixed or mounted to a hub 208 that is rotationally driven about an engine axis Aₓ, as described above. The casing 206 may include circumferential grooves or recesses in the form of a casing treatment 210. The blades 204 and recesses of the casing treatment 210 are arranged adjacent to each other when the gas turbine engine is assembled. The casing treatment 210 may be formed of a series of recesses that are arranged to overlap with a portion of the blades 204 as the blades 204 are rotated about the engine axis Aₓ.

The casing treatment 210 is provided to improve stability of flow through the compressor section 200 and to increase stall margins. However, these improves can result in performance losses. The location, shape, and geometry of the casing treatment may be designed to increase stall margins or may be designed for optimal flight operation (e.g., cruise or the like). However, casing treatments typically have a trade-off, in that if stall margin is improved, efficiency may go down, or vice versa. For example, maximum efficiency at design operation may be achieved by having no surface treatment of the casing around the compressor, such that a smooth surface is present between a tip of the blades and the casing surface. However, a treated surface may provide the greatest stall margin when the blades are rotating at lower than design specifications (e.g., when on ground or the like). By including casing treatments, the air at the tip of the blades may have a volume or space to flow into, thus reducing stall margins.

In view of this trade-off between improved stall margin and operational performance, embodiments of the present disclosure are directed to casing treatments that provide benefits at both ends (i.e., at both low flow/stall and at high flow/operational design). In accordance with some embodiments of the present disclosure, a casing treatment including a cover or covering of at least a portion of circumferentially-discrete casing treatment slots is provided. These partially-covered slots, recesses, channels, or the like may provide stability enhancements (e.g., increase stall margin) with no efficiency penalty (e.g., no penalty or even increased efficiency as compared to other casing treatments).

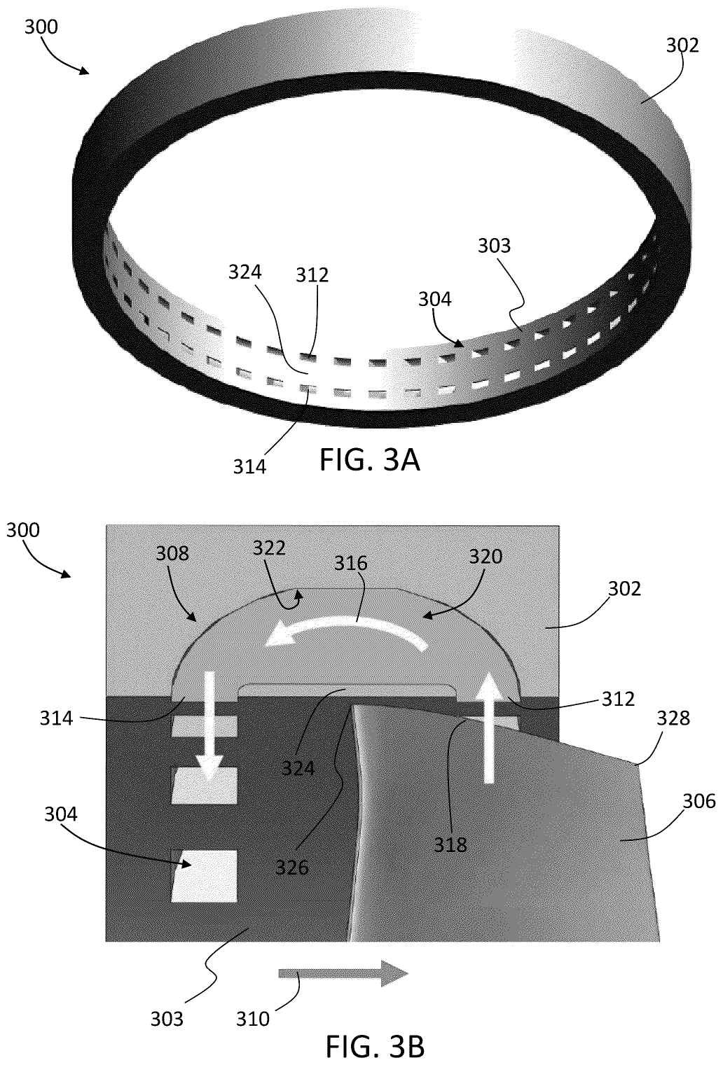

Referring now to FIGS. 3A-3B, schematic illustrations of a portion of a compressor section 300 in accordance with an embodiment of the present disclosure are shown. FIG. 3A illustrates a casing 302 of the compressor section 300 having a casing treatment 304 applied thereto. FIG. 3B illustrates a partial cross-sectional view of the casing 302 with a blade 306 arranged relative thereto. The blade 306 is mounted to a rotor disk or the like and is rotationally driven relative to the casing 302 within the compressor section 300.

The casing treatment 304 is formed of a number of covered channels 308. The covered channels 308 are fluidly connected to a core flow 310 of the compressor section 300. The core flow 310 is air passing through and being compressed by the compressor section 300, such as described above. The core flow 310 will pass by one or more vane stages and be compressed by one or more rotating rotors that include a plurality of blades (e.g., blade 306). On the illustrative drawing of FIG. 3B, the core flow 310 is flowing to the right on the page (from an inlet end toward an outlet end of a gas turbine engine).

Each covered channel 308 of the casing treatment 304 includes an inlet 312 and an outlet 314. As shown, the inlet 312 is downstream from the outlet 314 relative to the core flow 310. That is, a recirculation flow 316 that flows from the inlet 312 to the outlet 314 of the covered channel 308 is in a direction counter to or opposite the core flow 310. The recirculation flow 316 is caused, at least in part, by the shape of the blade 306 and the rotation thereof. As the blade 306 rotates relative to the casing 302, a blade tip 318 will push air into the covered channel 308 at the inlet 312, the recirculation flow 316 will then travel forward or counterflow relative to the core flow 310. The recirculation flow 316 will then re-enter the core flow 310 at the outlet 314 at a position upstream from the blade 306.

As noted, the casing treatment 304 is formed of a number of covered channels 308. The covered channels 308 are defined by openings to the core flow 310 (e.g., the core flow path through the compressor section 300) and a partially covered cavity 320 defined by a casing wall 322 and a cover wall 324. That is, the partially covered cavity 320 defined between the inlet 312 and the outlet 314 in an axial direction and between the cover wall 324 and the casing wall 322 in a radial direction relative to an axis through the casing 302. As a result of the cover wall 324, the recirculation flow 316 will travel forward (counter direction to the core flow 310) relative to the blade 306 for a distance (e.g., defined by axial length of cover wall 324 and/or axial length of the covered channel 308—with “axial” being relative to an engine axis). The cover wall 324 defines a portion of an interior surface 303 of the casing 302.

As shown in FIG. 3B, the casing treatment 304 is designed such that in operation a leading edge 326 of the blade tip 318 travels along a surface of the casing 302 that is between the inlet 312 and the outlet 314. Stated another way, the leading edge 326 of the blade tip 318 travels along or proximate an inner surface of the casing 302 that includes the cover wall 324. The outlet 314 is arranged forward or upstream from the leading edge 326 of the blade tip 318 (in the direction of the core flow 310). As illustratively shown, the blade 306 may be arranged to substantially align with the inlet 312. With this alignment, the leading edge 326 of the blade tip 318 is upstream from the inlet 312 (in the direction of the core flow 310) and a trailing edge 328 of the blade tip 318 is downstream from the inlet 312 (in the direction of the core flow 310).

In this embodiment, the covered channel 308 has a generally semi-circular, semi-elliptical, or semi-oblong shape, with the casing wall 322 defining a continuous curvature (not shown) or a curvature proximate the inlet 312 and outlet 314 and a flat landing or portion extending therebetween, as illustratively shown. The curvature of the casing wall 322 may be contoured to assist or direct the recirculation flow 316 through the covered channel 308. It will be appreciated that other geometric shapes for the covered channel 308 may be employed without departing from the scope of the present disclosure. As shown in FIGS. 3A-3B, the inlet 312 and the outlet 314 are substantially square or rectangular in shape. It will be appreciated that the geometric shape of the inlet and the outlet of the casing treatments of the present disclosure are not limited to square or rectangular and other shapes may be used, such as circular, triangular, oval, elliptical, polygonal, etc.

Modern aircraft engines may require large performance and stability margins to accommodate a deteriorated engine at off-design conditions, such as in an adverse weather environment. Several casing treatment concepts have been used in the past to increase the stall and stability margins. However, these treatments invariably result in performance loss. In contrast, embodiments of the present disclosure that include coverage of circumferentially-discrete casing treatment slots can achieve stability enhancements with little to no efficiency penalty at multiple operating conditions. Embodiments of the present disclosure are directed to a partially covered casing treatment slot that may significantly abate and even reverse flow recirculation within the channels of the casing treatment and the main gas pass at high flow condition (e.g., near peak efficiency condition) and maintain desired flow recirculation at low flow condition for stability enhancement. For example, in one non-limiting embodiment, a covered semi-circular slot (e.g., as shown in FIGS. 3A-3B) may be employed to achieve stability enhancement with no penalty in efficiency.

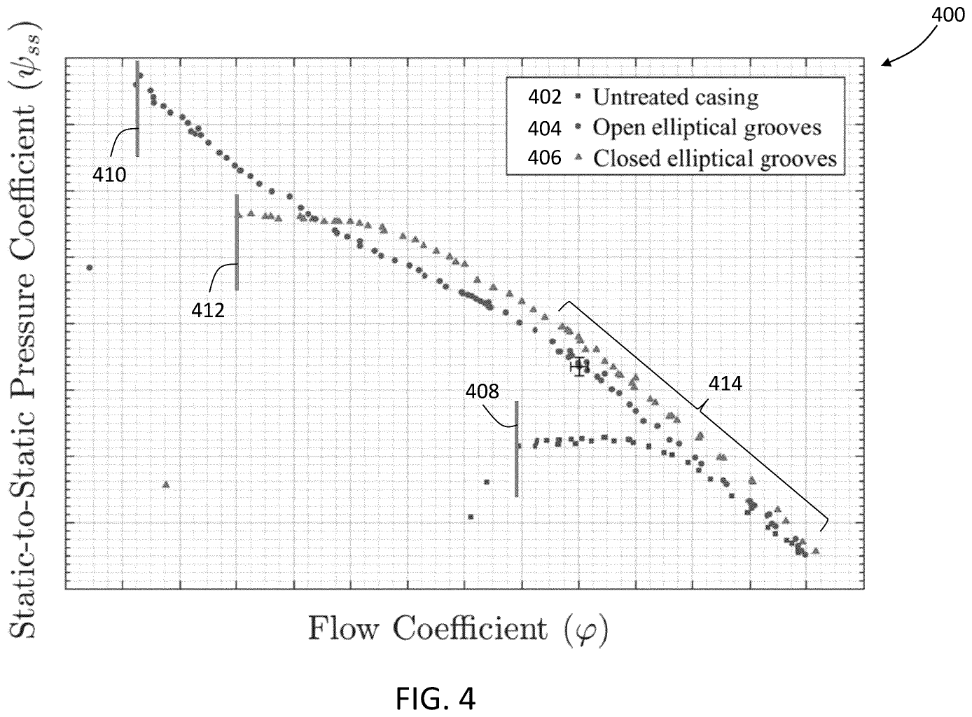

Referring now to FIG. 4, a schematic plot 400 illustrating compressor performance comparing different types of casing treatment is shown. The horizontal axis represents flow coefficient (φ) and the vertical axis represents static-to-static pressure coefficient (ψₛₛ). Plotted on plot 400 are a set of datapoints representing performance of an untreated casing (points 402), an open elliptical treatment (points 404), and a covered elliptical treatment (points 406).

At high flow coefficient (e.g., right side of plot 400), the static-to-static pressure coefficient is relatively low for all three treatments. The high flow coefficient represents near peak efficiency conditions (e.g., cruise or the like). At the flow coefficient decreases (e.g., moving left to right along the x-axis), the static-to-static pressure coefficient increases. For each treatment, as the static-to-static pressure coefficient increases, there becomes a point where stall occurs due to too little flow. This stall position or stall margin is defined where the static-to-static pressure coefficient decreases drastically, as illustratively shown. For example, the untreated casing (points 402) hits stall at a relatively high flow coefficient, indicated by line 408. In contrast, the uncovered or open casing treatment (points 404) provides significantly higher stall margin, indicated by line 410, but at best has similar performance as the untreated casing at high flow coefficients. Finally, when a casing treatment is provided with a partial cover (e.g., as shown and described above), the stall margin, indicated by line 412, is significantly increased as compared to the untreated casing, and thus provides significant stall margin improvement, even if such improvement may not be as extreme as that achieved with an uncovered casing treatment. Further, at the high flow coefficients, the performance is increased over both the untreated casing and the uncovered casing treatment, illustrated at region 414 of plot 400, where the static-to-static pressure coefficient is higher for the partial covered casing treatment at the same flow coefficients as compared to the other casing treatments. In one non-limiting example, the open elliptical casing treatment (points 404) may provide a stall margin improvement of up to 35% as compared to an untreated casing and a closed elliptical casing treatment (points 406) may provide a stall margin improvement of 50% or greater. Additionally, at high flow coefficients (e.g., right side of plot 400), as shown, there is no penalty through use of closed elliptical casing treatment (points 406, region 414). Further, as shown, there is a performance increase, as compared to the other configurations, even at high flow coefficients. For example, the closed elliptical casing treatment (points 406) can provide an increase of the pressure coefficient (as compared to other configurations) by about 3-10%, and, in some example embodiments, an increase of about 4%.

In the prior described embodiments, the casing treatment may include an inlet and outlet with a covered portion therebetween, with the inlet and the outlet substantially aligned in an axial direction (e.g., along the core flow direction and/or an engine axis). However, such arrangement is not intended to be limiting. For example, in some configurations of the present disclosure, the casing treatment may include partially covered channels that have the inlet and the outlet offset from each other along an axis (e.g., are at different circumferential positions relative to the engine axis). Further, for example, although the inlet and the outlet may be axially aligned, the geometry and path through the partially covered cavity may not be only an axial recirculation flow, which is shown in FIG. 3B.

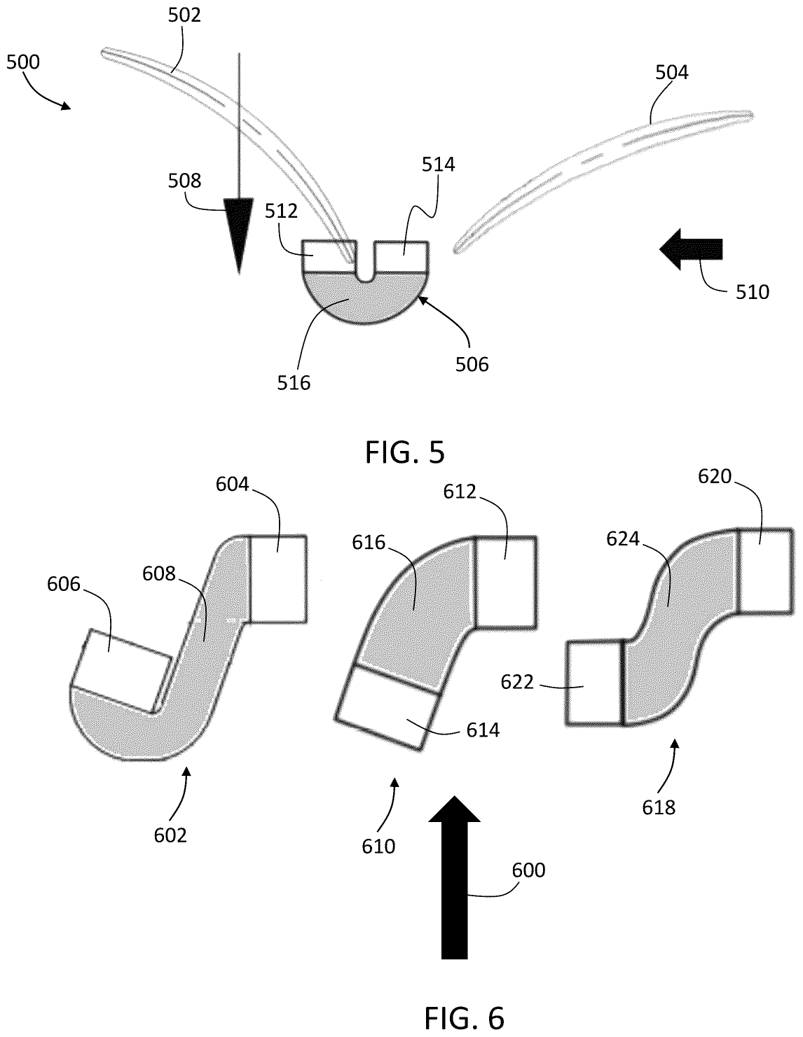

For example, now referring to FIG. 5, a schematic illustration of a portion of a compressor section 500 in accordance with an embodiment of the present disclosure is shown. The compressor section 500 includes a rotating blade 502, a stationary vane 504, and a casing treatment 506. The blade 502 rotates in a direction indicated by an arrow representative of a rotation direction 508 and a core flow through the compressor section 500 flows in a direction indicated by an arrow representative of a core flow direction 510. The vane 504 is positioned upstream from the blade 502 in the flow direction 510. The casing treatment 506 is positioned relative to the blade 502 such that an inlet 512 of the casing treatment 506 is aligned with a leading edge of the blade 502. An outlet 514 of the casing treatment 506 is arranged upstream from the inlet 512 in the flow direction. As such, as the blade 502 rotates relative to the casing treatment 506 it will push air into the inlet 512 which will then travel in a forward direction (i.e., counter to flow direction 510) to the outlet 514, resulting in a recirculation flow. The recirculation flow in the casing treatment 506 is reintroduced to the core flow at the outlet 514 upstream of the blade 502.

In this illustrative embodiment, the casing treatment 506 includes a cover wall 516. The cover wall 516 is similar to the cover wall described above, defining an enclosed, partially covered cavity. The casing treatment 506 has a substantially “U” shaped geometry. Due to the shape of the casing treatment 506, instead of the substantially radial and axial flow of the embodiment of FIGS. 3A-3B, in the casing treatment 506, the recirculation flow will additionally travel circumferentially through the shaped cavity of the casing treatment 506.

Referring to FIG. 6, schematic illustrations of a variety of different geometry shaped partially covered casing treatments in accordance with embodiments of the present disclosure. In FIG. 6, a flow direction 600 is shown which is aligned with or flows along an axial direction of a gas turbine engine in which the casing treatments are installed. A first example casing treatment 602 has a substantially “J” shape, having an inlet 604 arranged downstream from an outlet 606, and a cover wall 608 partially covering a cavity of the casing treatment 602. A second example casing treatment 602 has a substantially curved shape, having an inlet 612 arranged downstream from an outlet 614, and a cover wall 616 partially covering a cavity of the casing treatment 610. A third example casing treatment 618 has a substantially “S” shape, having an inlet 620 arranged downstream from an outlet 622, and a cover wall 624 partially covering a cavity of the casing treatment 618. In each of the casing treatments 602, 610, 618 illustrated in FIG. 6, the inlets 604, 612, 620 are arranged downstream from the outlets 606, 614, 622, with the covered portion, covered by the cover walls 608, 616, 624 being arranged between the inlets 604, 612, 620 and the outlets 606, 614, 622.

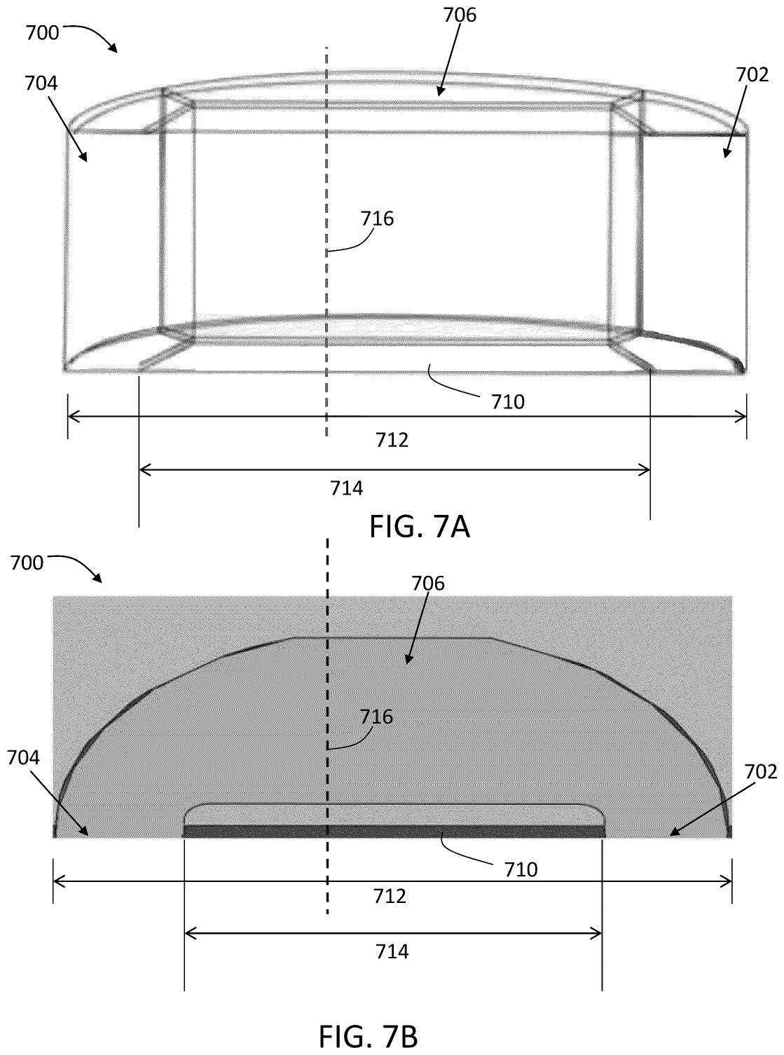

Referring now to FIGS. 7A-7B, schematic illustrations of a casing treatment 700 of a compressor section of a gas turbine engine in accordance with an embodiment of the present disclosure are shown. The casing treatment 700 includes an inlet 702, and outlet 704, and a partially covered cavity 706 that is defined between a casing wall 708 and a cover wall 710. The casing treatment 700 has a treatment length 712 and the cover wall 710 has a wall length 714. The cover wall 710 may be configured to cover between 30% and 90% of the casing treatment 700. That is, the cover length 712 may be between 30% and 90% of the treatment length 712. As a result, the size of the inlet 702 and the outlet 704 may define openings that span between 70% and 10% of the treatment length. In some embodiments, the inlet 702 and the outlet 704 may be substantially identical. For example, if the openings defined by the inlet 702 and the outlet 704 define 10% of the treatment length 712, each of the inlet 702 and the outlet 704 may have a length that is 5% of the treatment length 712. However, in other embodiments, the size of the inlet 702 is not required to be equal to the size of the outlet 704.

Also shown in FIGS. 7A-7B is a dashed line that represents a position of a leading edge 716 of a blade that is rotated relative to the casing treatment 700. In some embodiments, the leading edge 716 of the blade may be positioned to be closer to the outlet 704 than the inlet 702, as illustratively shown. Stated another way, the leading edge 716 may positioned between 0% and 50% along an extent of the cover wall 710 between the outlet 704 and the inlet 402 (i.e., closer to the outlet 704). In some non-limiting embodiments, the leading edge 716 may be positioned between 0% and 80% along the extent of the coverage surface between the outlet 704 and the inlet 702.

Advantageously, embodiments of the present disclosure provide for improved high flow performance and increased stall or stability margin, resulting in improved engine efficiencies. These improvements are provided at both ends of operational conditions, such as peak flow and also off-design conditions that typically may result in engine stall. Advantageously, the cover walls of the partially covered casing treatments of the present disclosure may significantly abate and even reverse flow recirculation within the cavity of the casing treatment and the main gas pass at high flow condition (e.g., near peak efficiency condition) and can maintain desired flow recirculation at low flow condition for stability enhancement with no penalty in near peak efficiency operation. Further, as described herein, such partially covered casing treatments increase efficiency at near peak efficiency operation.

The use of the terms “a”, “an”, “the”, and similar references in the context of description (especially in the context of the following claims) are to be construed to cover both the singular and the plural, unless otherwise indicated herein or specifically contradicted by context. The modifier “about” used in connection with a quantity is inclusive of the stated value and has the meaning dictated by the context (e.g., it includes the degree of error associated with measurement of the particular quantity). All ranges disclosed herein are inclusive of the endpoints, and the endpoints are independently combinable with each other. As used herein, the terms “about” and “substantially” are intended to include the degree of error associated with measurement of the particular quantity based upon the equipment available at the time of filing the application. For example, the terms may include a range of ±8%, or 5%, or 2% of a given value or other percentage change as will be appreciated by those of skill in the art for the particular measurement and/or dimensions referred to herein. It should be appreciated that relative positional terms such as “forward,” “aft,” “upper,” “lower,” “above,” “below,” and the like are with reference to normal operational attitude and should not be considered otherwise limiting.

While the present disclosure has been described in detail in connection with only a limited number of embodiments, it should be readily understood that the present disclosure is not limited to such disclosed embodiments. Rather, the present disclosure can be modified to incorporate any number of variations, alterations, substitutions, combinations, sub-combinations, or equivalent arrangements not heretofore described, but which are commensurate with the scope of the present disclosure. Additionally, while various embodiments of the present disclosure have been described, it is to be understood that aspects of the present disclosure may include only some of the described embodiments.

Accordingly, the present disclosure is not to be seen as limited by the foregoing description, but is only limited by the scope of the appended claims.

What is claimed is:

1. A compressor section of a gas turbine engine comprising:
a casing;
a rotor arranged within with casing, the rotor comprising a plurality of blades that are rotatable relative to the casing; and
a casing treatment applied to the casing, wherein the casing treatment comprises a plurality of covered channels each having an inlet and an outlet and a partially covered cavity defined between the inlet and the outlet in an axial direction and between a cover wall and a casing wall in a radial direction relative to an axis through the casing;
wherein a core flow through the casing is in a core flow direction and a recirculation flow through the plurality of covered channels is in a recirculation flow direction, the recirculation flow direction being counter to the core flow direction, and
wherein the inlet is at a position downstream relative to the outlet in the core flow direction.

2. The compressor section of claim 1, wherein a leading edge of a blade tip of each blade is positioned relative to the covered wall at a point between the inlets and the outlets of the casing treatment.

3. The compressor section of claim 2, wherein the point is closer to the outlet than the inlet.

4. The compressor section of claim 1, wherein the inlet and the outlet are separated in an axial direction and aligned in a circumferential direction, wherein the axial direction is along the axis through the casing and parallel to the core flow direction and wherein the circumferential direction is a direction of rotation of the rotor about the axis.

5. The compressor section of claim 1, wherein the inlet and the outlet are separated in an axial direction and offset in a circumferential direction, wherein the axial direction is along the axis through the casing and parallel to the core flow direction and wherein the circumferential direction is a direction of rotation of the rotor about the axis.

6. The compressor section of claim 1, wherein each covered channel has a generally J-shape between the inlet and the outlet.

7. The compressor section of claim 1, wherein each covered channel has a generally curved shape between the inlet and the outlet.

8. The compressor section of claim 1, wherein each covered channel has a generally S-shape between the inlet and the outlet.

9. The compressor section of claim 1, wherein each covered channel has a generally U-shape between the inlet and the outlet.

10. The compressor section of claim 1, wherein each covered channel of the casing treatment has a treatment length and the cover wall has a wall length, wherein the wall length is between 30% and 90% of the treatment length.

11. A gas turbine engine comprising:
a fan, a compressor section, a combustor section, and a turbine section arranged along an engine shaft, with a core flow passing through gas turbine engine in a core flow direction;
wherein the compressor section comprises:
a casing;
a rotor arranged within with casing, the rotor comprising a plurality of blades that are rotatable relative to the casing; and
a casing treatment applied to the casing, wherein the casing treatment comprises a plurality of covered channels each having an inlet and an outlet and a partially covered cavity defined between the inlet and the outlet in an axial direction and between a cover wall and a casing wall in a radial direction relative to an axis through the casing;
wherein a core flow through the casing is in a core flow direction and a recirculation flow through the plurality of covered channels is in a recirculation flow direction, the recirculation flow direction being counter to the core flow direction, and
wherein the inlet is at a position downstream relative to the outlet in the core flow direction.

12. The gas turbine engine of claim 11, wherein a leading edge of a blade tip of each blade is positioned relative to the covered wall at a point between the inlets and the outlets of the casing treatment.

13. The gas turbine engine of claim 12, wherein the point is closer to the outlet than the inlet.

14. The gas turbine engine of claim 11, wherein the inlet and the outlet are separated in an axial direction and aligned in a circumferential direction, wherein the axial direction is along the axis through the casing and parallel to the core flow direction and wherein the circumferential direction is a direction of rotation of the rotor about the axis.

15. The gas turbine engine of claim 11, wherein the inlet and the outlet are separated in an axial direction and offset in a circumferential direction, wherein the axial direction is along the axis through the casing and parallel to the core flow direction and wherein the circumferential direction is a direction of rotation of the rotor about the axis.

16. The gas turbine engine of claim 11, wherein each covered channel has a generally J-shape between the inlet and the outlet.

17. The gas turbine engine of claim 11, wherein each covered channel has a generally curved shape between the inlet and the outlet.

18. The gas turbine engine of claim 11, wherein each covered channel has a generally S-shape between the inlet and the outlet.

19. The gas turbine engine of claim 11, wherein each covered channel has a generally U-shape between the inlet and the outlet.

20. The gas turbine engine of claim 11, wherein each covered channel of the casing treatment has a treatment length and the cover wall has a wall length, wherein the wall length is between 30% and 90% of the treatment length.
